(19) United States
(12) Patent Application Publication
(10) Pub. No.: US 2009/0206295 A1
(43) Pub. Date: Aug. 20, 2009

(54) Universal attachable/detachable air extraction valve for re-sealable storage bags

(76) Inventor: Fletcher Morgan, St. Petersburg, FL (US)

Correspondence Address: JOHN S. HALE;GIPPLE & HALE, 6665-A OLD DOMINION DRIVE, MCLEAN, VA, 22101, US

(21) Appl. No.: 12/071,018

(22) Filed: Feb. 14, 2008

(51) Int. Cl. F16K 27/00; B65D 33/01

(52) U.S. Cl. 251/366; 383/103

(57) ABSTRACT

The invention is directed toward a universal self-sealing air extraction valve mounted to a self-closing plastic bag through which a pilot hole has been made. Air is extracted from the bag through the valve and prevented from returning to the bag after extraction, at which time, the valve is sealed with a cap assembly.

### RELATED APPLICATIONS

There is no related application.

### STATEMENT REGARDING FEDERALLY SPONSORED RESEARCH OR DEVELOPMENT

Not applicable.

### REFERENCE TO SEQUENCE LISTING, A TABLE OR A COMPUTER PROGRAM LISTING COMPACT DISC APPENDIX

None.

### BACKGROUND OF THE INVENTION

1. Field of Invention

The present invention is generally directed toward a detachable, reusable one way valve apparatus for self-sealing bags. The valve is ideally used in conjunction with a vacuum source to create a negative pressure environment in the self sealing bag relative to atmospheric pressure, thereby preserving or prolonging the useful life of the items contained in the bag.

2. Background of the Invention

The concept of vacuum sealing or otherwise removing air from a container in order to preserve or prolong the useful lifetime of its contents is well known. For example, one product currently in the prior art uses a combination of heat sealing a sheet of thermoplastic material and a motor driven vacuum pump to vacuum seal the specifically constructed bags. This product, however, is quite expensive and the many various electrical and mechanical components necessary for its operation are subject to malfunction. Additionally, the bag material required by this device is another significant expense with the added problem that the bag material is difficult to obtain. What is needed is a simpler, less expensive alternative that is able to duplicate the functionality of this far more expensive counterpart. Ideally, it should also be reusable and, not only simple to use, but also simple to manufacture and therefore potentially less prone to breakage. Moreover, the product should not require the use of specialized bags.

### SUMMARY OF THE INVENTION

Saving previously prepared foodstuffs and breaking down purchased bulk foodstuffs into individual or smaller portions has become a national phenomenon. While undertaking such actions can result in significant savings, these savings are often offset by the spoilage of portions that are not consumed quickly enough. Additionally, many find it convenient to prepare foods in large quantities that are broken down for later consumption over multiple meals. In these and similar circumstances, vacuum sealing is a well recognized method for preserving foods and has been in use since at least the development of the various home and commercial canning techniques developed during the 19^{th} and 20^{th} centuries. These traditional methods generally utilize cooling of the container's contents after it has been sealed in order to create a partial vacuum. However, devices are now available for home use utilizing pump mechanisms to directly evacuate containers. Unfortunately, these devices are relatively complicated and a malfunction in any of the various interconnected components renders these expensive devices unusable.

The present invention effectively addresses the disadvantages of these previously known technologies. It is a simple, easy to use, inexpensive, and rugged one way valve that may be attached to almost any sealable bag, or nearly any airtight container with an easily pierced sidewall. The only limitation of the present invention is that there needs to be sufficient access to the interior of the bag or container to enable fitment of the interior portion of the valve. The present invention is a one way valve specially adapted for airtight attachment to a container. After sealing the container, a vacuum source is attached to the valve in order to evacuate air contained in the bag. When the desired degree of vacuum or air extraction is achieved, the vacuum source is removed and air is prevented from returning to the container by operation of the one way valve in the valve passageway. The valve is easily detached from the container when no longer needed and may be re-used after handwashing or a washing in the dishwasher. The vacuum source need not be a substantial piece of equipment and may include vacuum provided by the user's own inhalation. Alternatively, when using a flexible container, for example, a self-sealing plastic bag (e.g., Ziploc™), the user may simply compress the container itself to expel the desired amount of air.

It is therefore an object of this invention to provide an inexpensive alternative to current vacuum sealing methods of self sealing flexible containers.

It is also an object of this invention to provide a more robust alternative to current vacuum sealing technologies.

It is yet another object of this invention to provide a reusable, easily cleaned vacuum valve for a self sealing bag.

It is another object of this invention to provide an intuitive, easy to use vacuum sealing device for a self sealing bag.

It is a further object of this invention to provide a reusable vacuum sealing technology for flexible containers.

It is another object of this invention to provide a vacuum sealing technology requiring no electrical power.

These and other objects, advantages, and novel features of the present invention will become apparent when considered with the teachings contained in the detailed disclosure along with the accompanying drawings.

### BRIEF DESCRIPTION OF THE DRAWINGS

FIG. 1 is a cross section view of the base member shown in FIG. 2of the valve of the present invention;

FIG. 2 is a side elevation view of the base member of the valve of the present invention;

FIG. 3 is a side elevation with a partial cutaway view of the second member of the present invention showing the one way valve and schematic attachment to a vacuum pump;

FIG. 4 is an elevation view of the second member of the present invention with the valve entryway being closed;

FIG. 5 is a perspective view of an exemplary fenestrating tool for use with the present invention;

FIG. 6 is a perspective view of the present valve invention mounted to a self sealing bag; and, FIG. 7 is an enlarged bottom plan view of the base member of FIG. 2 showing its anti-occlusive channels.

### DESCRIPTION OF THE INVENTION

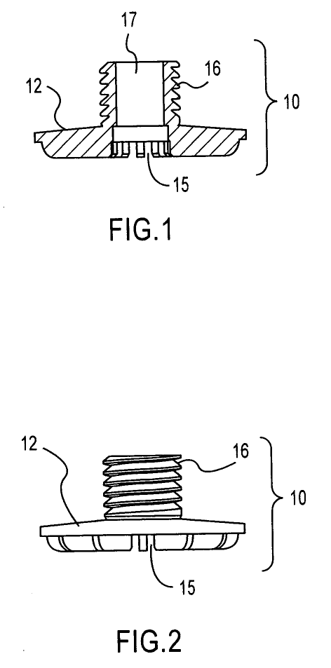

The preferred embodiment and best mode of the reusable valve invention 10 is shown in FIGS. 1 through 7. While the invention is described in connection with certain preferred embodiments, it is not intended that the present invention be so limited. On the contrary, it is intended to cover all alternatives, modifications, and equivalent arrangements as may be included within the spirit and scope of the invention as defined by the appended claims.

The invention may be constructed from any moldable material, but in a preferred embodiment, is constructed from various plastic polymer formulations, including but not limited to food grade silicone, fiberglass, nylon, polyvinyl chloride, polyethylene, polyfluoroethylene, polypropylene, polymethyl methacrylate, and other acrylics, polyurethanes, or their composites.

The base member 12 of the reusable valve 10 is shown in FIGS. 1, 2 & 7. The base member 12 has a circular base 14 defining radial channels 15 in the bottom surface 13, and has a hollow threaded neck 16 which defines a throughgoing passageway 17 facilitating extraction of air from the sealed bag 60. Anti-occlusive channels 15 are in communication with the distal end of the extraction passageway 17 and radiate therefrom along the bottom surface of the base member 12. The upper surface 18 of the base member 12 is seated against the inside surface 61 of the sealable bag 60. Positioning of the extraction passageway 17 is not critical provided that the passage 17 does not interfere with the airtight seal between the base member 12 and the second member 30, and that communication is maintained with the one way valve 23 mounted in the second member 30. Containers with relatively thin sidewalls will tend to collapse as they are evacuated with the possible result that the collapsing container walls and the material contained therein will occlude the extraction passageway 17 prior to achieving the desired degree of vacuum. The channels 15 present alternate air pathways leading to the extraction passageway 17. The channels are sufficiently narrow to preclude obstruction by all but the most malleable container materials, yet are nevertheless sufficient to facilitate adequate airflow when drawing a vacuum, thereby preventing premature occlusion of the extraction passageway 17. The base member 12 is shaped to complimentarily mate with a sealing element 34 of the aforementioned second member 30, with the base 12 being positioned inside a sealable bag 60 and the neck 16 extending through an aperture cut through a bag sidewall by fenestrating tool 50. Various methods of creating an airtight seal between the base member 12 and second member sealing element 34 are known to those with ordinary knowledge in this art. In a preferred embodiment, the base member 12 and second member 30 are predominantly manufactured from food grade silicone and an airtight seal is achieved due to the complimentary shapes of the base member 12 and second member 30 which engage opposite sides of a sidewall of bag 60.

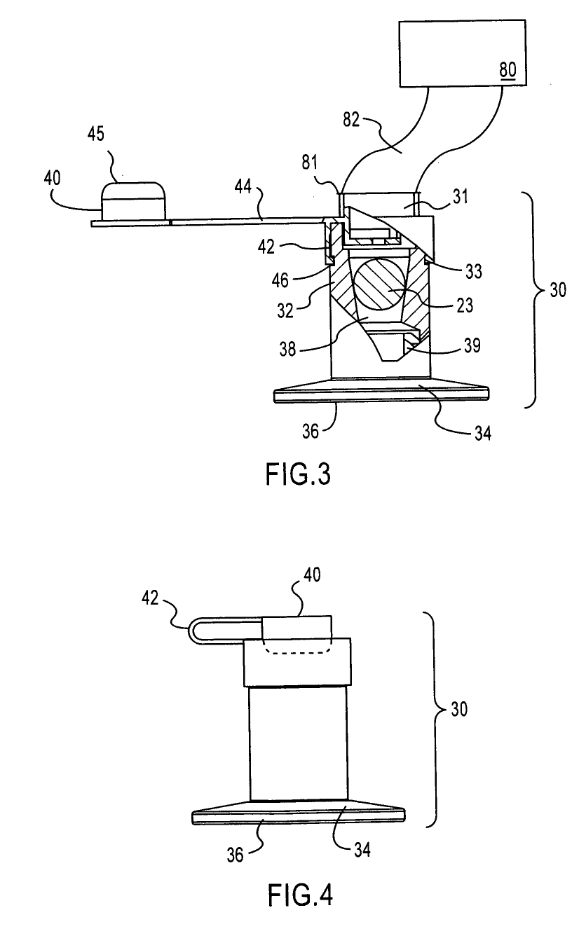

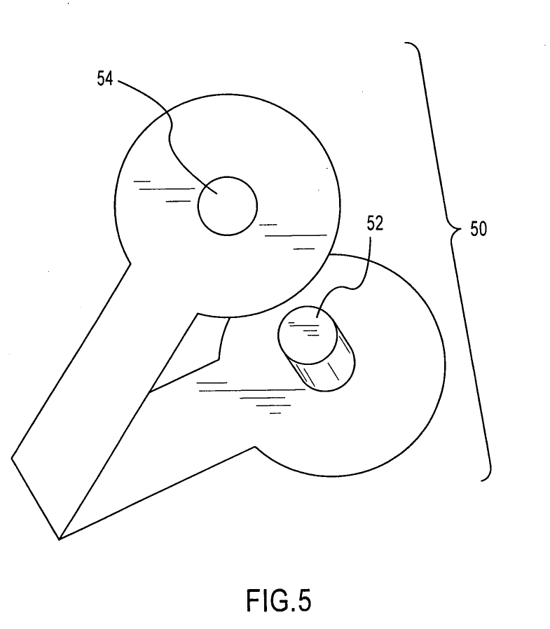

The second member 30 is depicted in a partial cross sectional view (FIG. 3) showing the one way valve housing 32 with a flanged circular base 34 which forms a secure sealing element. The second member base sealing element 34 has a planar bottom surface 36 which is seated on the outer surface 62 of the bag 60 forming a seal. The housing 32 defines a throughgoing air passageway 38, the lower end 39 of which is threaded to receive the threaded neck 16 of the base member 12. The top end of the housing 32 defines a stepped portion 31 which receives an end fitting 81 placed on hose 82 leading from the vacuum source 80. FIG. 4 shows the second member 30 with its auxiliary airtight cap assembly 40 in place, for ensuring an airtight seal after evacuation of a container. The cap assembly 40 has a flexible strip member 44 connected to a fastening cap 42 and a cap sealer member 45 formed on the end of the flexible strip member 44. The fastening cap 42 has a circularly projecting rib 46 which snap fits into the circular groove 33 formed in the external outer wall of housing 32. Also shown in FIG. 3 is a schematic representation of a vacuum source 80 to facilitate evacuation via the valve of the present invention. Vacuum sources are well known in the art, and a vacuum fitting 81 may therefore be formed to accommodate any such appropriate device. The vacuum fitting 81 is also sized to easily be inserted into the valve housing 32 via insertion into the fastening cap 42.

While the design of the preferred embodiment's one way valve 23 is a ball valve, it is noted that one way or check valves are well known and their use is encompassed by the present invention. The present valve 23 is seated in valve housing passageway 38 which has a decreasing diameter from the top toward the circular base sealing element 34. Examples of valves include, but are not limited to, flutter valves, diaphragm valves, swing check valves, clapper valves, stopper-check valves, and lift-check valves.

FIG. 5 is an exemplary fenestrating tool 50 optionally available for use with the present invention. A die 52 and complimentarily sized aperture 54 is utilized to cut a hole in the bag 60 for insertion of the neck 16 of base member 12.

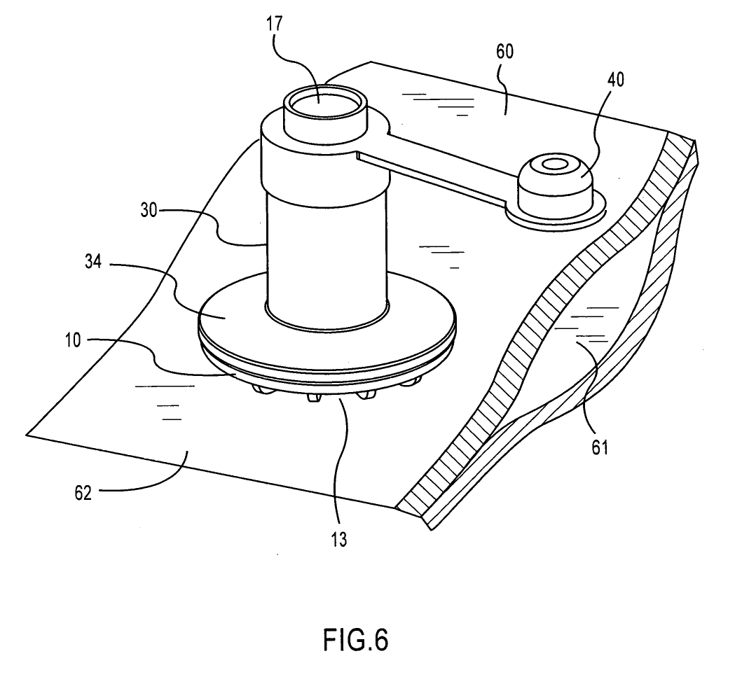

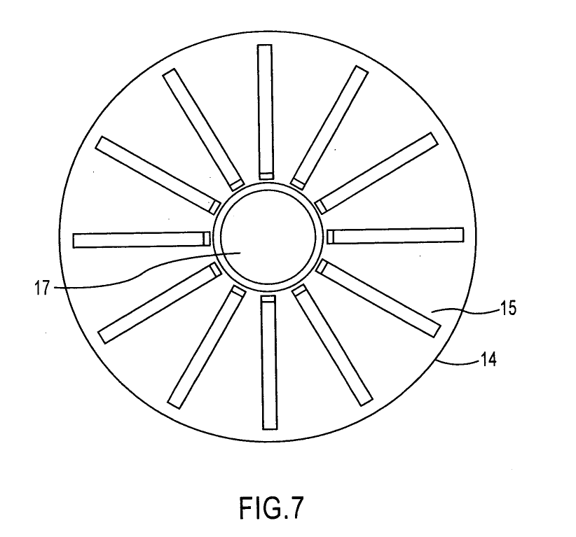

FIG. 6 shows the present invention attached to a sealable bag 60, such as a ZIPLOC™ bag, ready for filling, sealing of the bag, and evacuation. In operation, the fenestrating tool 50 is used to incise an appropriately sized hole in the bag 60. The base member 12 is then inserted through the previously incised aperture from the interior of the bag 60 whereby the increased diameter of the circular base 14 is positioned flush against the interior surface of a sidewall of the bag 60 with the neck 16 extending through the bag aperture. The neck 16 of the base member 12 may optionally include a pointed or slightly sharpened portion to facilitate piercing the sidewall. With the sidewall of the bag 60 now adjacent to the base member 12, the second member 30 is sealingly affixed atop the base member 12 by threading the neck 16 into the threaded portion 39 of the housing 32. Various clamping technologies, such as a friction fit, pinned fittings, and spring lock or other quick-connect type couplings could be used to connect the base member 12 and second external member 30.

After assembly of the present invention onto an appropriate container, the bag 60 is filled with foodstuffs, sealed, and a vacuum applied via the vacuum fitting 81 until the desired degree of vacuum in the bag is achieved. Thereafter, the vacuum source is removed, the one way valve 23 in the passageway 38 prevents re-infiltration of air into the container. An auxiliary airtight cap assembly 40 is included to provide an additional degree of sealing as is shown in FIG. 4. As previously mentioned, where the sidewalls of the container are exceptionally thin and/or flexible, for example a self-sealing type bag, the bag may also simply be compressed or squeezed to expel excess air, the present invention being particularly useful in preventing the re-entry of air upon release of tension on the bag. When the contents of the container have been consumed, the present invention is easily disassembled for handwashing or may simply be placed in a dishwasher. Thereafter, the valve may be reused on other sealable bags.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What is claimed is:

1. An air extraction valve for a sealable container comprising:
a base member defining a throughgoing extraction passageway;
a second member removeably mounted to said base member;
said second member comprising a housing defining a thoroughgoing passageway in communication with said base member passageway; and,
a one way valve means mounted to said second member throughgoing passageway.

2. An air extraction valve for a sealable container as claimed in claim 1 wherein said sealable container is a self-sealing storage bag.

3. An air extraction valve for a sealable container as claimed in claim 1 wherein said sealable container is a recloseable storage bag.

4. An air extraction valve for a sealable container as claimed in claim 1 wherein said sealable container is a re-sealable zipper storage bag.

5. An air extraction valve for a sealable container as claimed in claim 1 wherein said base member has a circular base portion with a neck portion extending from said circular base portion, said circular base portion defining a plurality of radially positioned grooves.

6. An air extraction valve for a sealable container as in claim 1 wherein said second member defines a vacuum source attachment point in communication with said one way valve means.

7. An air extraction valve for a sealable container as claimed in claim 1 wherein said base member comprises a circular base portion with a threaded neck extending from said base portion and said second member has at least a portion of its passageway threaded allowing said neck and second member to be threadably mounted to each other.

8. An air extraction valve for a sealable container as claimed in claim 1 wherein said base member and second member are mounted to one another.

9. An air extraction valve for a sealable container as claimed in claim 1 wherein said one way valve is a ball valve.

10. An air extraction valve for a sealable container as claimed in claim 1 wherein said one way valve is taken from a group consisting of a flutter valve, a diaphragm valve, a swing check valve, and a clapper valve.

11. An air extraction valve for a sealable container as claimed in claim 1 wherein said second member includes an airtight cover mounted to said housing and adapted to be secured in said passageway.

12. An air extraction valve for a sealable container as claimed in claim 1 wherein said base member and said second member are constructed of plastic.

13. An air extraction valve for a sealable bag comprising:
a base member defining a passageway therethrough, said base member comprising a base portion and a neck portion extending from said base portion and adapted to extend through a sidewall of said sealable bag;
a second member mountable to said base member defining a passageway therethrough, said base member neck portion being mounted in said second member passageway;
said base member passageway and said second member passageway being axially aligned; and,
a one way sealable valve mounted in one of said passageways.

14. An air extraction valve for a sealable container as claimed in claim 13 wherein a cap assembly is mounted to said second member, said cap assembly comprising an end cap secured to a flexible strip which is in turn secured to a fastening cap.

15. An air extraction valve for a sealable container as claimed in claim 14 wherein said cap assembly fastening cap has a housing with a circular projecting rib which fits into a groove formed in an external outer wall of said second member.

16. An air extraction valve for a sealable container as claimed in claim 13 wherein said second member thoroughgoing passageway decreases in diameter as it approaches said base member;
said second member having at least a portion of its passageway threaded; and
said second member having a ball valve moveably mounted in said second member passageway.

17. An air extraction valve for a sealable container as claimed in claim 13 wherein said base member comprises a circular base portion with a threaded neck extending from said base portion, said neck and base portion defining a throughgoing bore;
said base member having a base surface which defines a plurality of radial anti-occlusive channels.

18. An air extraction valve and re-sealable flexible container assembly comprising:
a base member defining an extraction passage therethrough;
said base member being mounted to a re-sealable flexible container so that said base member penetrates a sidewall of said flexible container and extends therethrough, said base member defining circular flange means sealing element positioned adjacent one surface of said sidewall; and,
a second member mounted to said base member, said second member comprising a housing defining a throughgoing passageway, a one way valve movably mounted in said passageway, said housing defining a circular end portion with a planar surface mounted on an outer surface of said sidewall of said container opposite said base member circular flange means sealing element.

19. An air extraction valve and re-sealable container assembly as claimed in claim 18 wherein said re-sealable container is a re-sealable zipper storage bag.

20. An air extraction valve and re-sealable container assembly as claimed in claim 18 wherein said one way valve is a ball valve.
